(19) United States
(12) Patent Application Publication
(10) Pub. No.: US 2009/0052090 A1
(43) Pub. Date: Feb. 26, 2009

(54) Disk device and electronic equipment using the same

(76) Inventors: Hideyuki Hashi, Osaka (JP); Hideki Kuwajima, Kyoto (JP)

Correspondence Address: RATNERPRESTIA, P.O. BOX 980, VALLEY FORGE, PA, 19482, US

(21) Appl. No.: 10/584,808

(22) PCT Filed: Nov. 17, 2005
(86) PCT No.: PCT/JP2005/021130

§ 371 Date: Jun. 28, 2006

(30) Foreign Application Priority Data
Nov. 19, 2004 (JP) 2004-335640

(51) Int. Cl. G11B 5/54

(52) U.S. Cl. 360/254; G9B/5.181

(57) ABSTRACT

A disk device includes an actuator which can be turned around a shaft bearing portion as a turning center in a radius direction of a recording medium, a ramp block which holds a part of the actuator on the occasion of retracting a head portion of the actuator, a circuit substrate portion which carries out at least any one of transmission and reception of a signal to and from at least a head portion and the actuator, an upper side chassis, and a lower side chassis, and a turning shaft of the actuator, the ramp block and the circuit substrate portion have fastening portions on both sides in a perpendicular direction to the recording medium, respectively, and by fastening the fastening portions from the upper side chassis and the lower side chassis, the actuator, the ramp block and the circuit substrate portions are incorporated in the upper side chassis and the lower side chassis.

### TECHNICAL FIELD

This invention relates to a disk device which is equipped with a floating type signal conversion element, and more particularly, relates to a disk device which is capable of easily carrying out at least any one of assembly and disassembly, and an electronic equipment using it.

### BACKGROUND ART

A magnetic disk device such as a hard disk device has become mounted even on a portable small-size electronic equipment such as a portable telephone device and a portable audio player device, depending on a rapid miniaturization/realization of large capacity in recent years. By further miniaturization and realization of low cost from now on, it is expected that an application to these electronic devices will be extended.

In the suchlike magnetic disk device, as a point for realizing further miniaturization and low cost, there is a wiring structure for carrying out giving and receiving a signal between a magnetic, a spindle motor and an actuator and a control section.

Firstly, a wiring connection method in a conventional disk device will be explained. Here, the explanation will be carried out by use of a magnetic device such a hard disk device as one example of the disk device.

FIG. 14 is a plan view showing such a situation that an upper side chassis was removed in conventional magnetic disk device 130 having a floating type signal conversion element (hereinafter, simply described as a magnetic head), and FIG. 15A is a partial cross sectional view which shows a cross section of conventional disk device 130 at a P-P line in FIG. 14, and FIG. 15B is a partial cross sectional view which shows a cross section of conventional disk device 130 at a Q-Q line in FIG. 14.

In FIGS. 14, 15A and 15B, actuator 131 has suspension 132 with relatively low stiffness, plate spring portion 133 and support arm 134 with relatively high stiffness. On a lower surface of an one end side of suspension 132, head slider 135, on which a magnetic head (not shown in the figure) was mounted, is disposed.

In addition, it is configured in such a manner that magnetic recording medium 136 is rotated by spindle motor 137, and at the time of recording and reproducing of magnetic disk device 130, depending on rotation of magnetic recording medium 136, levitation force which is received by head slider 135 by an air flow that is generated between head slider 135 and magnetic recording medium 136, bias force due to plate spring portion 133 of actuator 133 which biases head slider 135 to magnetic recording medium 136 (so-called load loading) balance out, and head slider 135 is floated from magnetic recording medium 136 with given quantity, and a magnetic head is also floated from magnetic recording medium 136 with give quantity.

Actuator 131 turns around turning shaft 139 as a center at the time of recording and reproducing of magnetic disk device 130, by an operation of voice coil 138 disposed at an end portion of support arm 134 which is opposite to such a side that head slider 135 is disposed. By this means, a magnetic head, which is mounted on head slider 135, is positioned against a desired track in magnetic recording medium 136, and magnetic disk device 130 is capable of carrying out recording and reproducing.

At the time that magnetic disk device 130 stops, actuator 131 turns around turning shaft 139 as a center and moves toward an outside of magnetic recording medium 136. On the outside of magnetic recording medium 136, head holding portion 140 is disposed, and guide portion 132a, which is formed on a front edge of suspension 132, runs on taper portion 140a formed on head holding portion 140, and thereby, it is possible to prevent absorption of head slider 135 supported by suspension 132 and the magnetic head and magnetic recording medium 136.

In addition, in conventional magnetic disk device 130, spindle motor 137, turning shaft 139 of actuator 131 and head holding portion 140 are attached to lower side chassis 143, respectively.

Further, in conventional magnetic disk device 130, in order to supply an electric signal for controlling rotation of spindle motor 137 from electric circuit main substrate 146 which will be described later, motor wiring body 141 using, for example, a flexible wiring substrate (FPC substrate) is disposed on spindle motor 137. In addition, for the purpose of giving and receiving a recording signal or a reproducing signal between electric circuit main substrate 146 and a magnetic head of actuator 131 and giving and receiving a control signal between electric circuit main substrate 146 and voice coil 138 for positioning the magnetic head at a predetermined position on magnetic recording medium 136, actuator wiring body 142 using, for example, the FPC substrate is disposed on actuator 131.

Further, for the purpose of dust control etc., upper side chassis 144 is attached to lower side chassis 143 so as to cover internal each constituent element to seal it hermetically.

In addition, in conventional magnetic disk device 130, electric circuit main substrate 146, on which electric circuit components 145 for controlling magnetic disk device 130 are mounted, as shown in for example, FIG. 15A or 15B, is attached to a bottom surface of lower side chassis 143.

On electric circuit main substrate 146, motor connector 147 and actuator connector 148 are disposed, and connector 141a of motor wiring body 141 is connected to motor connector 147, and connector 142a of actuator wiring body 142 is connected to actuator connector 148.

In this manner, conventional disk device 130 was configured in such a manner that a control signal from electric circuit main substrate 146 is sent through motor connector 147 to spindle motor 137, and is sent through actuator connector 148 to a magnetic head or voice coil 138 (e.g., see, Japanese Patent Unexamined Publication No. 4-181587, Japanese Patent Unexamined Publication No. 7-14362, Japanese Utility Model Unexamined Publication No. 3-71490 or Japanese Patent Unexamined Publication No. 63-127482.).

However, in the above-described conventional magnetic disk device, the turning shaft of the actuator, the head holding portion and the actuator wiring body are disposed on the lower side chassis together with a structural portion such as the spindle motor for rotating the magnetic recording medium, and the upper side chassis is attached so as to cover an inside against the lower side chassis in a hermetically sealed manner. In the suchlike configuration, in case that any failure occurred in, for example, the magnetic recording medium or the spindle motor, there is need to remove at least the actuator from the lower side chassis, after the upper side chassis was removed, on the occasion of exchange of the magnetic recording medium or the spindle motor, since the magnetic recording medium and the actuator are disposed redundantly in a rotating axis direction of the magnetic recording medium. In addition, also at the time of assembly after repair is completed, there is such a disadvantage that there is need to assemble in reverse order, and long time is required at the time of disassembly and assembly to take a lot of trouble.

### DISCLOSURE OF THE INVENTION

The present invention was made in view of the suchlike problems, and aims to provide a disk device which is not troublesome at the time of disassembly and assembly, and an electronic equipment using it.

A disk device of the present invention is equipped with a recording medium, a rotating portion which rotates the recording medium, a head portion which carries out at least any one of reproducing and recording a signal from and on the recording medium, an actuator portion which supports the head portion and can be turned around a shaft bearing portion as a turning center in a radius direction of the recording medium, a ramp portion which holds a part of the actuator portion on the occasion of retracting the head portion of the actuator portion, a circuit substrate portion which carries out at least any one of transmission and reception of a signal to and from at least the head portion and the actuator portion, an upper side chassis, and a lower side chassis, wherein each of the shaft bearing portion of the actuator portion, the ramp portion and the circuit substrate portion has fastening portions on both sides thereof in a perpendicular direction to the recording medium, the actuator portion, the ramp portion and the circuit substrate portions being fixed to the upper side chassis and the lower side chassis.

By the suchlike configuration, the shaft bearing portion of the actuator portion, the ramp portion and the circuit substrate portion have fastening portions on both sides, respectively, and by a simple method of fastening this fastening portion through the upper side chassis and the lower side chassis, or releasing this fastening, it is possible to carry out assembly or disassembly of a device, and therefore, it is possible to provide a disk device which is not troublesome at the time of disassembly and assembly.

In addition, the disk device may be configured in such a manner that the ramp portion has a ramp block portion which holds a part of the actuator portion, and a ramp post portion which is disposed on the fastening portion.

According to the suchlike configuration, it is further possible to realize such a configuration that fabrications of respective members are easy, by separating the ramp block portion and the ramp post portion.

In addition, the disk device may be configured in such a manner that the ramp block portion and the ramp post portion are formed integrally.

According to the suchlike configuration, it is further possible to configure the ramp block portion and the ramp post portion integrally, and therefore, it is possible to realize reduction of the number of components.

Further, the disk device may be configured in such a manner that the circuit substrate portion has a FPC portion on which an electrically conductive pattern is formed, and a FPC post portion which passes through the FPC portion and the fastening portion is disposed on the FPC post portion.

According to the suchlike configuration, it is further possible to realize such a configuration that fabrications of respective members are easy, by separating the FPC portion and the FPC post portion.

In addition, the disk device may be configured so as to be equipped with a positioning member which determines a relative positional relation of the ramp post portion and the FPC post portion.

According to the suchlike configuration, a positional relation of the ramp post portion and the FPC post portion is further determined, and therefore, it is possible to realize a configuration which is much easier for assembly.

In addition, the disk device may be configured in such a manner that the circuit substrate portion has an amplification circuit portion which amplifies an output from the head portion.

According to the suchlike configuration, it is further possible to process a minute signal in the vicinity of the head portion, and therefore, it is possible to suppress generation of noises, and it becomes possible to give and receive a stabilized signal, and it is possible to improve reliability.

In addition, the disk device may be configured in such a manner that the ramp post portion is of a shape having at least two circular cylindrical portions with different radiuses each other and at least one step portion between the circular cylindrical portions, and when, among at least the two circular cylindrical portions, the ramp block portion is fitted in the circular cylindrical portion on the side of the upper side chassis against the step portion and the ramp post portion is fastened to the upper side chassis by use of the fastening portion, the ramp block portion is sandwiched by the upper side chassis and the step portion.

According to the suchlike configuration, it is possible to fix a position of the ramp block portion by a simple configuration.

In addition, the disk device may be configured in such a manner that the FPC post portion is of a shape having at least two circular cylindrical portions with different radiuses each other and at least one step portion between the circular cylindrical portions, and the step portion of the FPC post portion is fixed to the FPC portion.

According to the suchlike configuration, it is further possible to fix a position of the FPC portion by a simple configuration.

Further, the disk device may be configured in such a manner that the FPC post portion is solder-fixed to a ground line formed on the FPC portion.

According to the suchlike configuration, it further becomes possible to connect the ground line of the FPC portion to ground, more surely.

In addition, the disk device may be configured so as to be equipped with a wiring body having an electrically conductive portion for carrying out at least any one of reception and transmission of an electric signal from and to a rotating portion, at an end portion, and it is configured in such a manner that the FPC portion has an electrically conductive portion for carrying out at least any one of transmission and reception of an electric signal to and from the head portion and the actuator portion, and a connecting portion for contacting the electrically conductive portion of the wiring body, and the positioning member has a front edge portion which is sandwiched by the FPC portion for pressing the connecting portion of the FPC portion in a direction of the electrically conductive portion of the wiring body, and the connecting portion of the FPC portion is brought into contact with the electrically conductive portion of the wiring body by pressing force due to the front edge portion of the positioning member, and thereby, the connecting portion of the FPC portion and the electrically conductive portion of the wiring body are electrically connected.

According to the suchlike configuration, it is further possible to separate the upper side chassis and the lower side chassis in such a situation that the circuit substrate portion is fixed to the upper side chassis and the wiring body is fixed to the lower side chassis, and therefore, it becomes possible to realize such a configuration that disassembly and assembly are easy.

In addition, the electronic equipment may be configured in such a manner that the actuator portion, the positioning member and the FPC portion are attached to the upper side chassis and the rotating portion and the wiring body are attached to the lower side chassis and, by assembling the upper side chassis and the lower side chassis, the connecting portion of the FPC portion and the electrically conductive portion of the wiring body are brought into contact with each other by pressing force of the front edge portion of the positioning member and thereby, connected electrically.

According to the suchlike configuration, it is further possible to electrically connect the FPC portion and the wiring body by assembling the upper side chassis and the lower side chassis, and therefore, it is possible to separate the upper side chassis and the lower side chassis in such a situation that the actuator portion, the positioning member and the FPC portion are fixed to the upper side chassis and the rotating portion and the wiring body are fixed to the lower side chassis, and therefore, it is possible to realize such a configuration that disassembly and assembly are easy.

Next, an electronic equipment of the present invention is characterized by being equipped with the disk device of the present invention.

According to the suchlike configuration, the shaft bearing portion of the actuator portion, the ramp portion and the circuit substrate portion have fastening portions on both sides, respectively, and by a simple method of fastening this fastening portion through the upper side chassis and the lower side chassis, or releasing this fastening, it is possible to carry out assembly or disassembly of a device, and therefore, it is possible to provide an electronic equipment which is not troublesome at the time of disassembly and assembly and on which a disk device is mounted.

In addition, the electronic equipment may be configured in such a manner that a control section for controlling the disk device is disposed on the side of the electronic equipment.

According to the suchlike configuration, it is further possible to carry out connection of the control section which is disposed on the side of the electronic equipment and the disk device through one terminal portion, and therefore, it becomes possible to carry out connection simply.

Further, the electronic equipment may be configured in such a manner that a surface of the upper side chassis or the lower side chassis of the disk device is attached to the electronic equipment.

According to the suchlike configuration, it is further possible to realize an electronic equipment with high stiffness and excellent impact resistance.

As described above, according to a disk device and an electronic equipment using it in the present invention, it is possible to realize such a configuration that it is difficult to take a trouble at the time of disassembly and assembly.

### BRIEF DESCRIPTION OF THE DRAWINGS

FIG. 1 is a plan view which shows a major configuration of a magnetic disk device in an embodiment of the present invention.

FIG. 2 is an expansion plan view which shows a configuration of a relay wiring body of the magnetic disk device in the embodiment of the present invention.

FIG. 3A is a side view on the occasion that the relay wiring body of the magnetic disk device in the embodiment of the present invention is assembled.

FIG. 3B is a side view in which a portion of a R portion in FIG. 3A of the magnetic disk device in the embodiment of the present invention is enlarged.

FIG. 3C is a cross sectional view of a FPC post of the magnetic disk device in the embodiment of the present invention.

FIG. 3D is a cross sectional view which shows another example of the FPC post of the magnetic disk device in the embodiment of the present invention.

FIG. 4A is a plan view which shows a configuration of a pressing elastic member of the magnetic disk device in the embodiment of the present invention.

FIG. 4B is a side view of the pressing elastic member of the magnetic disk device in the embodiment of the present invention.

FIG. 5A is a partial cross sectional view which shows a cross section, at an A-A line in FIG. 1, of the magnetic disk device in the embodiment of the invention.

FIG. 5B is a partial cross sectional view which shows a cross section, at a B-O₁-O₂-O₃-B line in FIG. 1, of the magnetic disk device in the embodiment of the invention.

FIG. 5C is a view which shows a configuration in the vicinity of an air filter of the magnetic disk device in the embodiment of the present invention.

FIG. 6A is a partial cross sectional view which shows a cross section, at a C-O₄-C line in FIG. 1, of the magnetic disk device in the embodiment of the invention.

FIG. 6B is a view which shows a configuration in the vicinity of a shaft bearing portion of an actuator of the magnetic disk device in the embodiment of the present invention.

FIG. 7 is a partial cross sectional view of vicinity of a contact portion of a relay wiring body and a motor wiring body, of the magnetic disk device in the embodiment of the present invention.

FIG. 8A is a plan view for explaining processes of assembling the magnetic disk device in the embodiment of the present invention.

FIG. 8B is a plan view for explaining processes of assembling the magnetic disk device in the embodiment of the present invention.

FIG. 9A is a plan view for explaining processes of assembling the magnetic disk device in the embodiment of the present invention.

FIG. 9B is a plan view for explaining processes of assembling the magnetic disk device in the embodiment of the present invention.

FIG. 10 is a perspective view which shows a configuration of an assembly jig on the occasion of assembling the magnetic disk device in the embodiment of the present invention.

FIG. 11A is a plan view for explaining processes of assembling the magnetic disk device in the embodiment of the present invention.

FIG. 11B is a plan view for explaining processes of assembling the magnetic disk device in the embodiment of the present invention.

FIG. 12 is a partial perspective view which shows another example of the pressing elastic member of the magnetic disk device in the embodiment of the present invention.

FIG. 13 is a block diagram which shows a configuration of an electronic equipment in which the magnetic disk device in the embodiment of the present invention is incorporated.

FIG. 14 is a plan view showing such a situation that an upper side chassis is removed in a conventional magnetic disk device having a floating type signal conversion element.

FIG. 15A is a partial cross sectional view which shows a cross section, at a P-P line in FIG. 14, of the conventional magnetic disk device.

FIG. 15B is a partial cross sectional view which shows a cross section, at a Q-Q line in FIG. 14, of the conventional magnetic disk device.

### DESCRIPTION OF REFERENCE NUMERALS AND SIGNS

1 spindle motor
1a motor wiring body (second wiring body)
1b,21b electrically conductive portion
2 rotating center shaft
3 magnetic recording medium
4 turning shaft
4a penetration screw portion (fastening portion)
5 actuator (head supporting device)
5a actuator wiring body
5b tab portion
5c signal wiring connecting portion
5d wiring attaching portion
5e cut and raised portion
6 ramp block
6a,51a,51b,51c protruding portion
6b,9e,21d,21e positioning hole
7 relay wiring body (first wiring body)
7a preamplifier circuit portion voice coil
9,123 pressing elastic member
9a flat surface portion
9b front edge portion
9c,9d,9f,9g,10a,21c,31a,31b,52a through-hole
10 lower side chassis
11 magnetic disk device
21 flexible wiring substrate (FPC substrate)
21a,121 base material portion
22 electric circuit component
23,56 connector
24 gasket
25 connecting portion
31 reinforcing plate
32 FPC post
32a,33a,33b,61a screw portion (fastening portion)
32b,32c,61b,61c circular cylindrical portion
32d,61e step surface
32e corner portion
41a,41b width
51 spacer
52 upper side chassis
53 electric circuit main substrate
54,55,62,63,64,65 screw
57 hole portion
58 air filter
61 ramp post
61d flange portion
71 HDA portion
72,76 disk unit
73 control section
74,77 electronic equipment
75 electronic equipment circuit section
101 assembly jig
102,103,104 positioning post
105 substrate
106 concave portion
121a bifurcation portion
122 elastic portion

### BEST MODE FOR CARRYING OUT THE INVENTION

Hereinafter, a disk device in an embodiment of the present invention will be explained by using a magnetic disk device as an example.

### EMBODIMENT

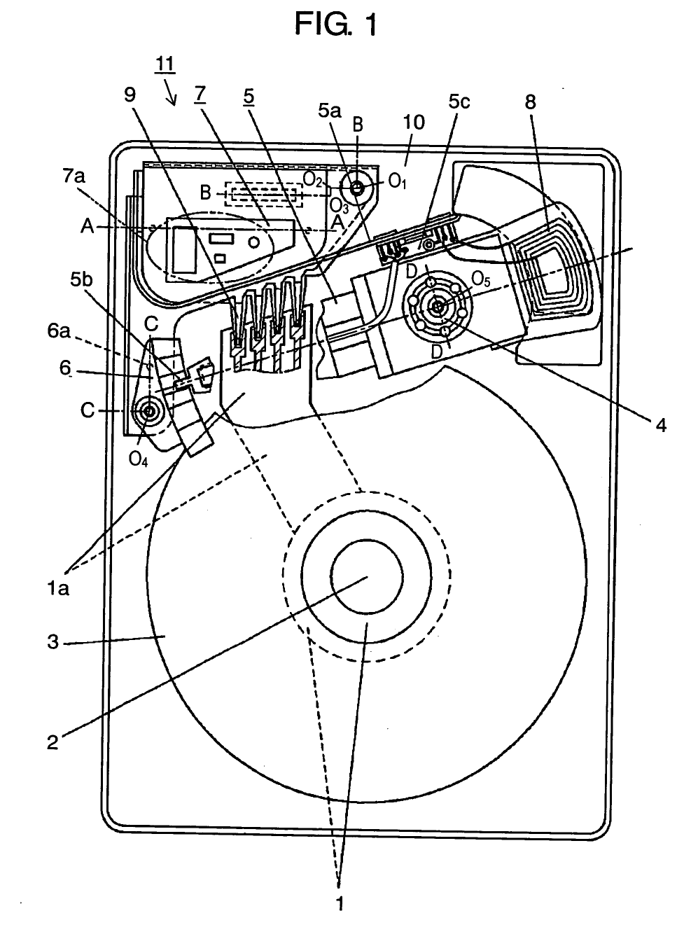

A magnetic disk device in an embodiment of the present invention will be explained by use of drawings from FIG. 1 to FIG. 13.

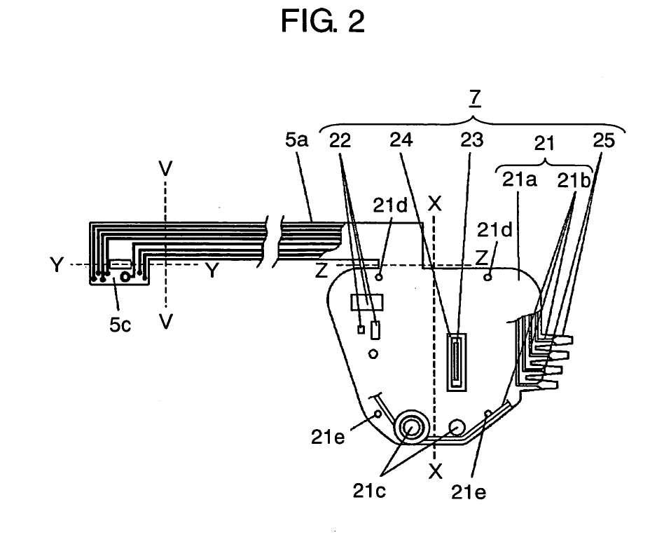

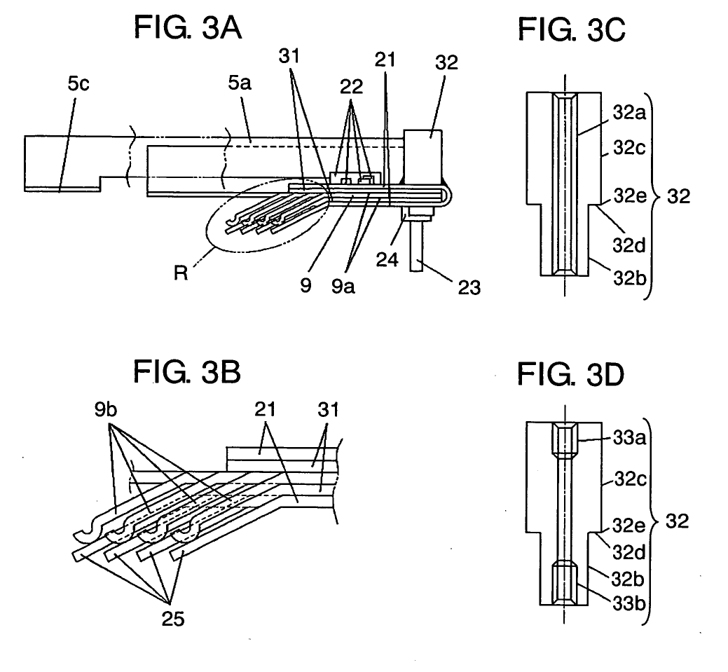

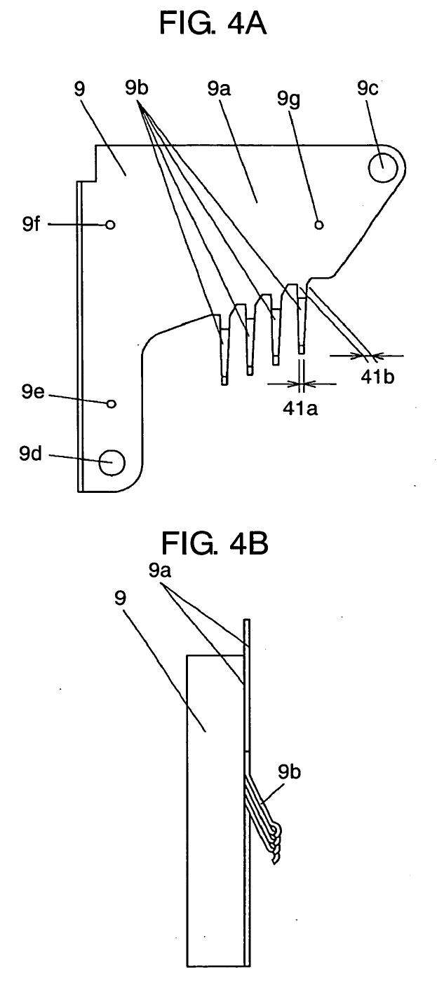

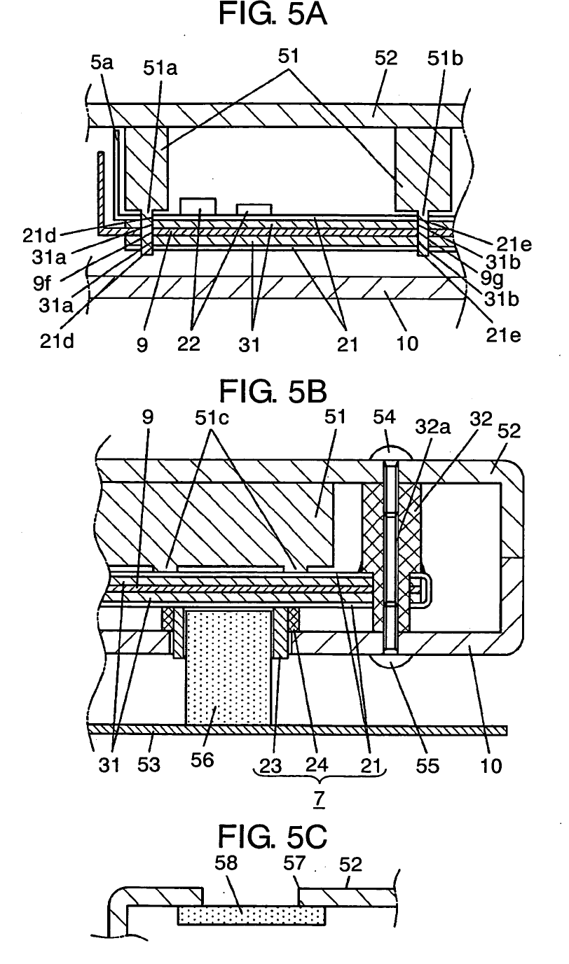

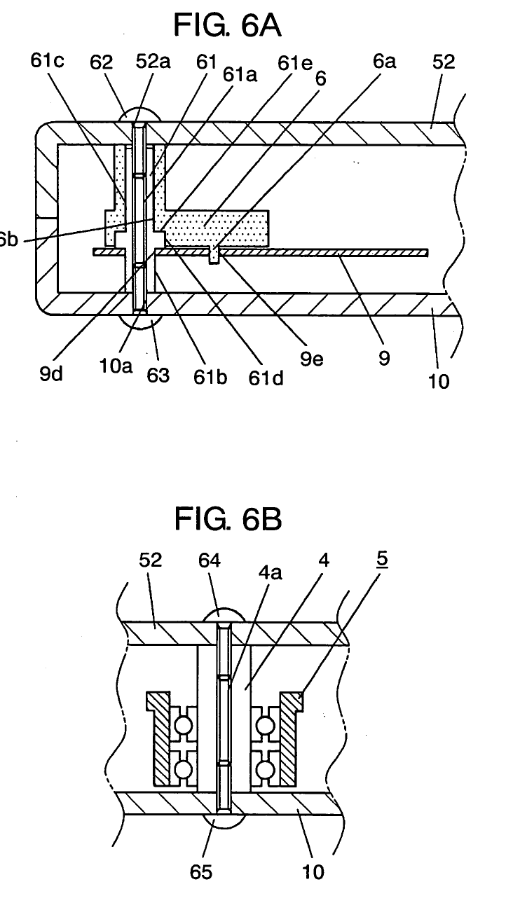

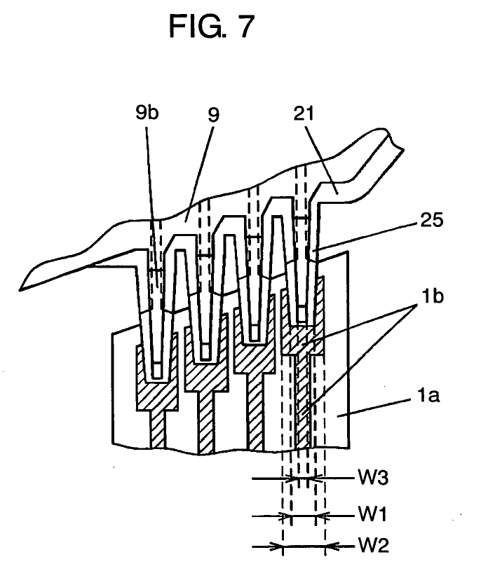

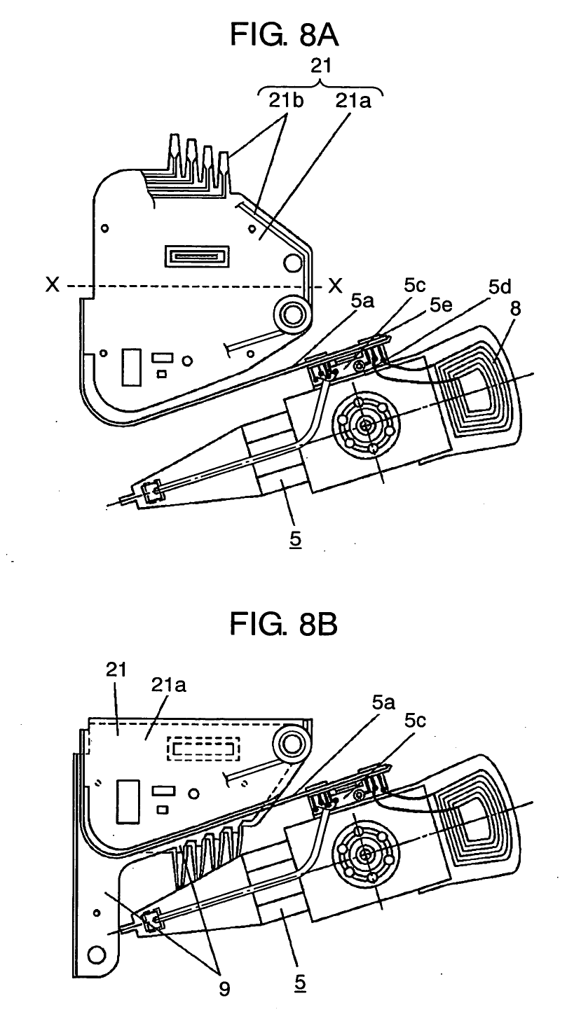

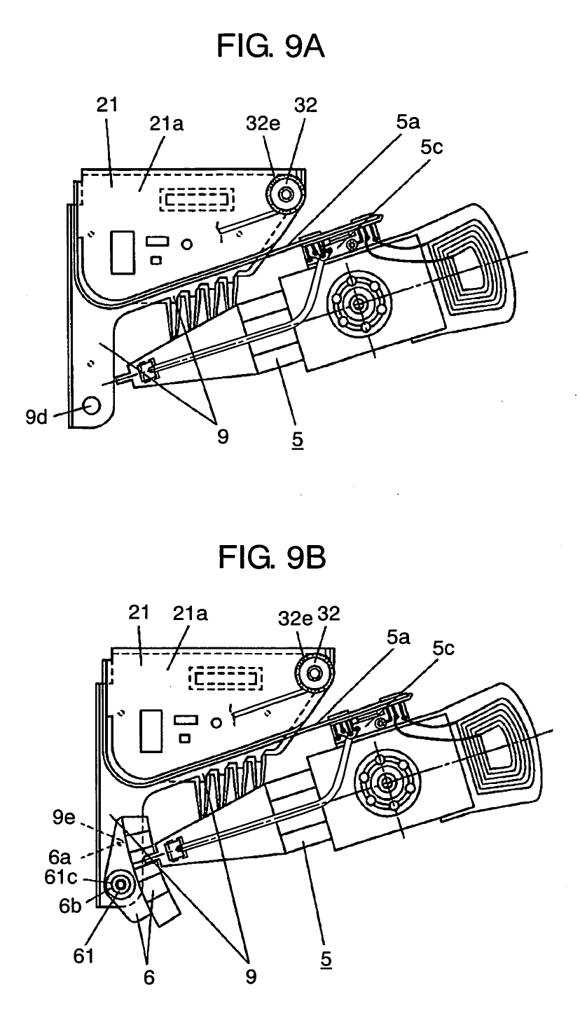

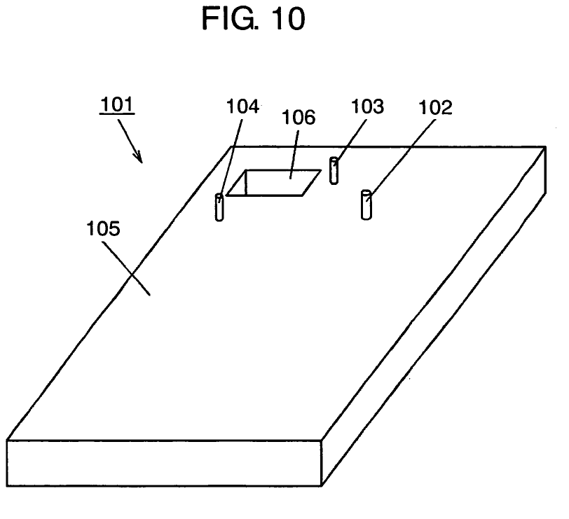

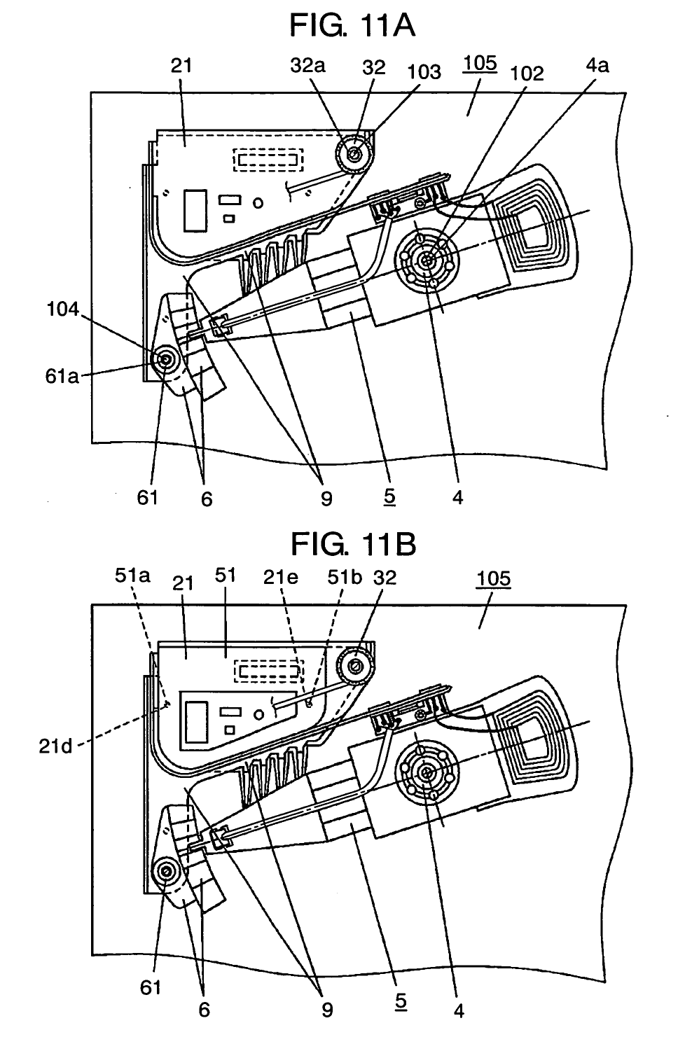

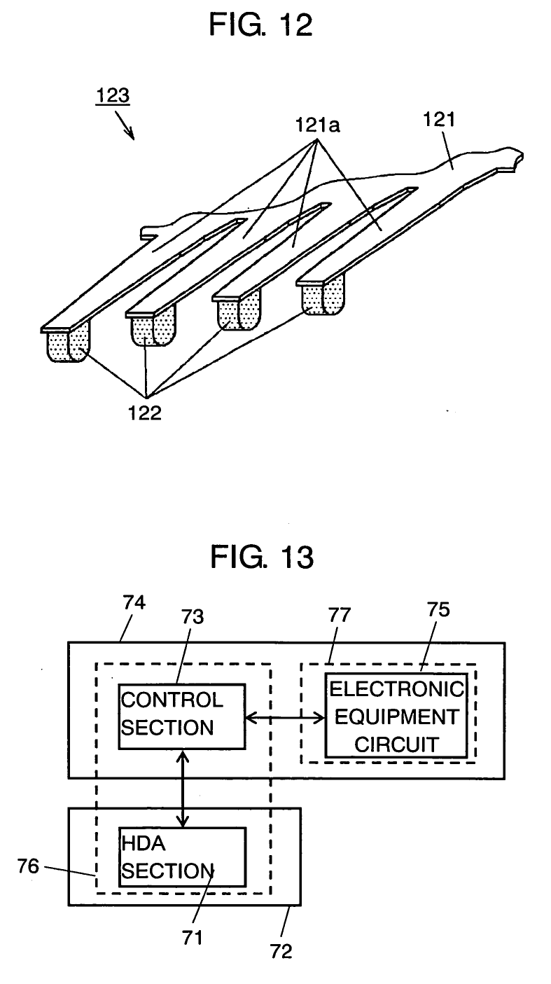

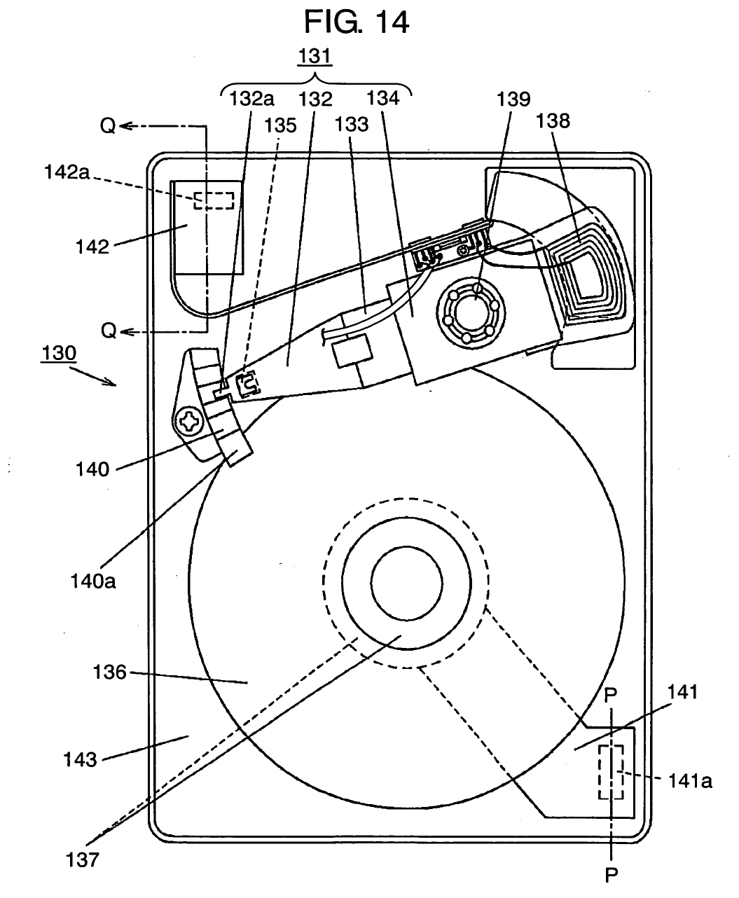

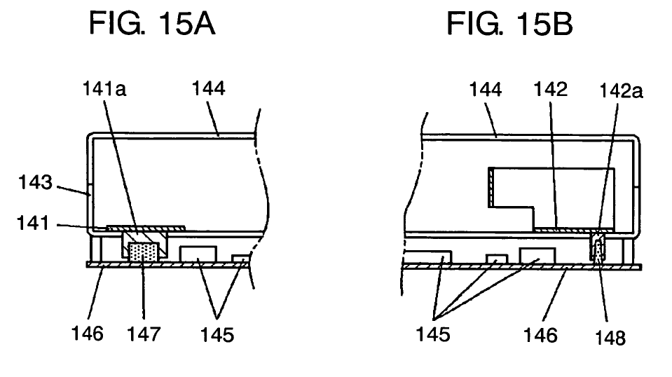

FIG. 1 is a plan view which shows a major configuration of magnetic disk device 11 in an embodiment of the present invention, and FIG. 2 is an expansion plan view which shows a configuration of its relay wiring body 7, and FIG. 3A is a side view on the occasion that relay wiring body 7 is assembled, and FIG. 3B is a side view in which a portion of a R portion in FIG. 3A of magnetic disk device 11 in the embodiment of the present invention is enlarged, and FIG. 3C is a cross sectional view of its FPC post 32, and FIG. 3D is a cross sectional view which shows another example of the FPC post, and FIG. 4A is a plan view which shows a configuration of its pressing elastic member 9, and FIG. 4B is a side view of pressing elastic member 9, and FIG. 5A is a partial cross sectional view which shows a cross section, at an A-A line in FIG. 1, of magnetic disk device 11, and FIG. 5B is a partial cross sectional view which shows a cross section at a B-O₁-O₂-O₃-B line in FIG. 1, and FIG. 5C is a view which shows a configuration in the vicinity of its air filter 58, and FIG. 6A is a partial cross sectional view which shows a cross section at a C-O₄-C line in FIG. 1, and FIG. 6B is a view which shows a configuration in the vicinity of shaft bearing portion 4 of its head supporting device 5, and FIG. 7 is a partial plan view of vicinity of a contact portion of relay wiring body 7 and motor wiring body 1a, of magnetic disk device 11 in the embodiment of the present invention, and each drawing from FIG. 8A to FIG. 11B is a view for explaining major processes of assembling a disk drive section of the disk device, respectively, and FIG. 8A is a plan view for explaining a first process, and FIG. 8B is a plan view for explaining a second process, and FIG. 9A is a plan view for explaining a third process, and FIG. 9B is a plan view for explaining a fourth process, and FIG. 10 is a perspective view of an assembly jig, and FIG. 11A is a plan view for explaining a fifth process, and FIG. 11B is a plan view for explaining a sixth process, and furthermore, FIG. 12 is a partial perspective view which shows another example of the pressing elastic member.

FIG. 1 shows such a situation that upper side chassis 52 of magnetic disk device 11 is removed, and illustrates such a situation that upper side chassis 52 and an upper side yoke which is disposed on upper side chassis 52 are omitted. A housing of magnetic disk device 11 has upper side chassis 52 (also described as a first housing) and lower side chassis 10 (also described as a second housing).

Firstly, magnetic disk device 11 in the embodiment of the present invention is, as shown in FIG. 1, equipped with magnetic recording medium 3 which is supported rotatably by rotating center shaft 2 of spindle motor 1 that is a rotating portion, head supporting device (described as an actuator or an actuator portion) 5 which has a magnetic head, that is a signal conversion element for recording information on magnetic recording medium 3 and reproducing information recorded on magnetic recording medium, at its one end side, and is supported by turning shaft 4 so as to be able to be turned, and has tab portion 5b at its front edge, ramp block (also described as a ramp block portion, and also described as a ramp portion together with ramp post 61) 6 which is disposed at a retracted position of actuator 5 and has a plurality of inclinatory inclined surfaces and a plurality of flat surfaces, relay wiring body (also described as a first wiring body or simply as a wiring body) 7 on which preamplifier circuit section 7a, that is an amplification circuit section for amplifying and taking out a reproduction signal from the magnetic head with high precision, is disposed, motor wiring body (second wiring body) 1a which supplies a drive electric current to spindle motor 1, actuator wiring body 5a which is formed integrally with relay wiring body 7 for giving and receiving a signal to and from the magnetic head that is disposed on one end side of actuator 5, and giving and receiving a signal to and from voice coil 8 which is disposed at the other end and is a turning portion for positioning of the magnetic head, and pressing elastic member 9 which is sandwiched by relay wiring body 7 and electrically connects relay wiring body 7 and motor wiring body 1a by a method which will be described later.

In addition, in magnetic disk device 11 in the embodiment of the present invention, the above-described each constituent element is stored in an inside of lower side chassis 10, and a control section, which controls each constituent element, is disposed on-electric circuit main substrate 53 (not shown in FIG. 1, and see, FIG. 5B) which is separately disposed on an outside of the housing. The above-described example explained such an example that preamplifier circuit section 7a is disposed on relay wiring body 7, but preamplifier circuit section 7a may be mounted on electric circuit main substrate 53 which is separately disposed on an outside of the housing and relay wiring body 7 is only a wiring portion which an electric signal simply passes through.

Next, relay wiring body 7 of magnetic disk device 11 in the embodiment of the present invention will be explained by use of FIG. 2. As shown in FIG. 2, relay wiring body 7 in the embodiment of the present invention is equipped with an electric wiring member like flexible wiring substrate (hereinafter, described as a FPC portion or a FPC substrate, and also described as a circuit substrate portion together with FPC post 32) 21, electric circuit component 22 which configures an electric circuit such as preamplifier circuit section 7a disposed on FPC substrate 21, connector 23 which is electric signal sending means for being connected to electric circuit main substrate 53 (not shown in FIG. 2) disposed outside, and is a terminal portion, and gasket 24 for sealing a peripheral portion of connector 23 from outside air.

In addition, FPC substrate 21 of relay wiring body 7 of magnetic disk device 11 in the embodiment of the present invention is such an electric wiring member that electrically conductive portion 21b is formed by a predetermined pattern on base material portion 21 which is composed of an insulating material, and connecting portion 25, which is bifurcated into a plurality of pieces, is formed on a right side of FPC substrate 21 in FIG. 2. It is configured in such a manner that a front edge portion of connecting portion 25 of FPC substrate 21 is electrically conductive and is brought into contact with a plurality of electrically conductive portions 1b of corresponding motor wiring body 1a (see, FIG. 7) and connected electrically.

There is not necessarily such a necessity that the front edge portion of connecting portion 25 of FPC substrate 21 is of a bifurcated shape into a plurality of pieces, and it may be configured in such a manner that it is formed as an integrated shape, and a plurality of electrically conductive portions 21b are disposed on its front edge portion so as to correspond to each of electrically conductive portion 1b of motor wiring body 1a.

Further, in magnetic disk device 11 of the embodiment of the present invention, actuator wiring body 5a is formed on base material portion 21a of FPC substrate 21 of relay wiring body 7. In addition, through-hole 21c, which FPC post 32 (FIG. 3A), that is a FPC post portion, passes through, in such a situation described later that FPC substrate 21 @is folded back, is disposed in FPC substrate 21.

In addition, relay wiring body 7 in magnetic disk device 11 of the embodiment of the present invention is, as shown in FIGS. 3A and 3B, used in such a situation that relay wiring body 7 is folded by nearly 180° (mountain folding) so as to be opposed to base material portion 21a of FPC substrate 21, at a broken line X-X line in FIG. 2. In addition, it is used in such a situation that flat surface portion 9a of pressing elastic member 9 shown in FIG. 4A is sandwiched by FPC substrate 21, through two pieces of reinforcing plates 31 which are fixed to a surface of base material portion 21a which is on the opposite side of a surface on which electrically conductive portion 21b of FPC substrate 21 is formed and uses, for example a SUS plate material etc., and FPC substrate 21 is doubled.

As shown in FIGS. 3A and 3B, in magnetic disk device 11 of the embodiment of the present invention, it becomes such a situation that pressing elastic member 9 and two reinforcing plates 31 are bonded, when a double-sided adhesive tape etc. are applied on front-back both surfaces of flat surface portion 9a of pressing elastic member 9 and pressing elastic member 9 is sandwiched by two reinforcing plates 31 fixed to FPC substrate 21.

Next, pressing elastic member 9, which is a positioning member of magnetic disk device 11 in the embodiment of the present invention, will be explained. Pressing elastic member 9, in magnetic disk device 11 in the embodiment of the present invention, has a shape as shown in FIGS. 4A and 4Bm and it is possible to manufacture it by use of an elastic material having a spring characteristic such as phosphor bronze. At one end portion of pressing elastic member 9, a plurality of bifurcated front edge portions 9b are formed, so as to correspond to each of a plurality of connecting portions 25 which are disposed at a front edge portion of FPC substrate 21. FIG. 4B is a side view viewed from a right direction of FIG. 4A, and front edge portion 9b is folded back in a direction heading for a paper surface, in FIG. 4A. By this means, it becomes possible for front edge portion 9b to give biasing force against connecting portion 25 of FPC substrate 21.

In addition, in pressing elastic member 9, through-hole 9c which FPC post 32, that will be described later, passes through and ramp post through-hole 9d which ramp post 61, that is a ramp post portion, passes through, positioning hole 9e of ramp block 6, through-holes 9f and 9g which two positioning protruding portions 51c of spacer 51 (see, FIGS. 5A and 5B) that will be described later, pass through, are formed.

In magnetic disk device 11 of the embodiment of the present invention, when relay wiring body 7 is disposed at a predetermined position to pressing elastic member 9, each of plural front edge portions 9b of pressing elastic member 9 pushes corresponding connecting portion 25 among a plurality of connecting portions 25 of FPC substrate 21, and they are brought into contact with a plurality of electrically conductive portions 1b (see, FIG. 7) of motor wiring body 1a, and connecting portion 25 of FPC substrate 21 and electrically conductive portion 1b of motor wiring body 1a are electrically connected.

In order to restrain weakening of pressing force to connecting portion 25 by front edge portion 9b of pressing elastic member 9, by the force from an outside such as impact, especially impact in a rotating direction, it is desirable, as shown in FIG. 4A, that front edge portion 9b of pressing elastic member 9 is formed in such a manner that width 41b of a root portion becomes larger than width 41a of a front edge portion. That is, it is desirable to form it so as to satisfy

width 41a<width 41b.

In other words, front edge portion 9b of pressing elastic member 9 of magnetic disk device 11 in the embodiment of the present invention is formed in such a shape that its cross sectional area is made smaller than a portion of a root to a portion of a front edge.

Here, a configuration of periphery of FPC substrate 21 in magnetic disk device 11 in the embodiment of the present invention will be explained. In magnetic disk device 11 in the embodiment of the present invention, FPC post 32 has upper circular cylindrical portion 32c and lower circular cylindrical portion 32b with different radiuses each other, in which screw portion 32a is formed at a central portion, as shown in FIG. 3C, in such a situation that pressing elastic member 9 is sandwiched by relay wiring body 7, and lower circular cylindrical portion 32b of FPC post 32 is penetrated through through-hole 21c disposed in FPC substrate 21 and through-hole 9c of pressing elastic member 9.

Step surface (also described as a step portion) 32d between upper circular cylindrical portion 32c and lower circular cylindrical portion 32b of FPC post 32 is brought into contact with FPC substrate 21, and FPC substrate 21 and FPC post 32 are solder-fixed at a boundary of upper circular cylindrical portion 32c and step surface 32d, i.e., over entire circumference of corner portion 32e. It is configured in such a manner that a wiring, which becomes GND, is formed on FPC substrate 21 at the soldering portion, and FPC substrate 21 becomes a ground line (earth line) through FPC post 32, when magnetic disk device 11 is assembled. There is not such a necessity that FPC post is formed so as to have penetrating screw portion 32a at a central portion, and as shown in FIG. 3D, it may be configured in such a manner that screw portion 33a and screw portion 33b are disposed at both side end portions as fastening means. In addition, in this case, screw portion 33a and screw portion 33b may be not necessarily disposed coaxially.

Further, in magnetic disk device 11 in the embodiment of the present invention, signal wiring connecting portion 5c of actuator wiring body 5a formed integrally with relay wiring body 7 is folded by nearly 90° in a paper surface upper direction (valley folding direction) at a broken line Y-Y line shown in FIG. 2, and folded by nearly 180° in a mountain folding direction at a broken line V-V line, and furthermore, actuator wiring body 5a is folded by nearly 90° in a paper surface upper direction (valley folding direction) at a broken line Z-Z line.

By doing in this manner, it is possible to attach signal wiring connecting portion 5c in actuator wiring body 5a to lower side chassis 10 in the vicinity of actuator 5, as shown in FIG. 1, and to connect signal wirings from a magnetic head and voice coil 8.

Next, as shown in FIGS. 5A and 5B, two pieces of positioning protruding portion 51a and positioning protruding portion 51b, which are disposed on spacer 51, are fitted in and positioned by 4 pieces of positioning holes 21d and positioning holes 21e (see, FIG. 2) which are disposed so as to be penetrated through FPC substrate 21 that is doubled by sandwiching pressing elastic member 9, and thereby, spacer 51 is mounted, and gasket 24, FPC substrate 21 which sandwiches pressing elastic member 9, and spacer 51 are sandwiched by lower side chassis 10 and upper side chassis 52, and thereby, it is possible to fix a position. FPC post 32 and upper side chassis 52 and lower side chassis 10 are fastened, respectively, by screw 54 and screw 55 which are fastening means. Also in reinforcing plate 31, through-hole 31a and through-hole 31b are disposed, respectively, at positions which correspond to two pieces of positioning protruding portion 51a and positioning protruding portion 51b which are disposed on spacer 51, respectively. In addition, in this example, the fastening means is described by use of combination of a male screw and a female screw, but there is no need to limit to this at any rate, and publicly known technology such as a male screw and a nut or a set-in type may be used.

In magnetic disk device 11 in the embodiment of the present invention, gasket 24 for surely sealing outside air is disposed at an external peripheral portion of connector 23 which is disposed on FPC substrate 21 of relay wiring body 7, but as gasket 24, it is possible to use an elastic member such as a rubber material for keeping air tightness, e.g., silicon rubber (hardness 550).

In addition, as shown in FIG. 5B, in magnetic disk device 11 in the embodiment of the present invention, a contact surface of protruding portion 51 which is disposed on one end surface of spacer 51 contacts FPC substrate 21, at a corresponding position on the opposite side to FPC substrate 21, of such a position that FPC substrate and gasket 24 contact, by carrying out positioning of a position of spacer 51 to FPC substrate 21. Therefore, spacer 51, FPC substrate 21 and gasket 24 of connector 23 are sandwiched by lower side chassis 10 and upper side chassis 52, and thereby, it becomes possible to prevent dust intrusion by gasket 24 (particle cut), and it is possible to keep air tightness of an inside of an equipment, more surely.

By inserting connector 56 on electric circuit main substrate 53 which is disposed on an outside of lower side chassis 10 of magnetic disk device 11, into connector 23 which is disposed on FPC substrate 21, it is possible to connect relay wiring body 7 and electric circuit main substrate 53.

A contact surface of spacer 51 and FPC substrate 21 may be of a hollow rectangular shape which is nearly the same as a contact surface of gasket 24 and FPC substrate 21, and in addition, it may be configured in such a manner that spacer 51 and FPC substrate 21 contact partially at plural places at a corresponding position on the opposite side to FPC substrate 21, of the contact surface of gasket 24 and FPC substrate 21.

Further, in magnetic disk device 11 of the embodiment of the present invention, in order to keep its air tightness by gasket 24, it is desirable to configure in such a manner that a female type connector is used as connector 23 and gasket 24 is fitted in its outside.

Further, in magnetic disk device 11 of the embodiment of the present invention, in order to avoid contact of electric circuit components 22 which configure a circuit such as a preamplifier circuit section 7a which is disposed on FPC substrate 21 and spacer 51, spacer 51 is formed so as to have a space at a portion on FPC substrate 21 where electronic circuit component 22 is disposed. Further, it is also possible to configure in such a manner that, in order to prevent a barometric pressure difference from being generated between an inside of a housing which is configured by upper side chassis 52 and lower side chassis 10 and a housing outside, hole portion 57 is disposed on a part of upper side chassis 52, for example, as shown in FIG. 5C, and air filter 58 is disposed on its inner surface for the purpose of particle cut (dust removal). This air filter 58 may be disposed on at least any one of upper side chassis 52 and lower side chassis 10.

Here, a configuration of periphery of ramp block 6 of magnetic disk device 11 in the embodiment of the present invention will be explained. In pressing elastic member 9 of magnetic disk device 11 of the embodiment of the present invention, as shown in FIG. 6A, ramp post through-hole 9d which lower circular cylindrical portion 61 of ramp post 61, where screw portion 61a is formed at a central portion, passes through, and positioning hole 9e for carrying out positioning of ramp block 6 are disposed (see, FIG. 4A).

In ramp block 6 of magnetic disk device 11 in the embodiment of the present invention, positioning protruding portion 6a is disposed at such a position that it is fitted in positioning hole 9e of pressing elastic member 9, and positioning hole 6b is disposed at such a position that it is fitted in upper circular cylindrical portion 61c of ramp post 61.

At the time of assembly of magnetic disk device 11, ramp post 61 is mounted on pressing elastic member 9 so as to arrange in such a manner that lower circular cylindrical portion 61b of ramp post 61 passes through ramp post through-hole 9d of pressing elastic member 9.

After that, positioning hole 6b of ramp block 6 is fitted in upper circular cylindrical portion 61c of ramp post 61, and positioning protruding portion 6a of ramp block 6 is fitted in positioning hole 9e of pressing elastic member 9, and ramp block 6 is mounted on upper step surface (also described as a step portion) 61e of flange portion 61d of ramp post 61, and thereby, it is possible to determine a position of ramp block 6 to pressing elastic member 9.

Further, passing through through-hole 52a of upper side chassis 52, screw 62 tights up ramp block 6 toward screw portion 61a at a central portion of ramp post 61. By this means, ramp block 6 is sandwiched between upper side chassis 52 and upper step surface 61e of flange portion 61d of ramp post 61, and fixed. There is not such a necessity that ramp block 6 and ramp post 61 are separate members as described above, and they may be formed integrally as one member.

Further, lower side chassis 10 and ramp post 61 are fastened by screw 63 through through-hole 10a of lower side chassis 10, by using screw portion 61a at a central portion of ramp post 61 as a penetrating screw portion. As shown in FIG. 6A, ramp post 61 is fixed to upper side chassis 52 and lower side chassis 10 at its upper and lower ends, and thereby, it is possible to carry out positioning of ramp block 6 at a predetermined position. By this means, a position of relay wiring body 7 is also determined. There is not such a necessity that screw portion 61a, which is disposed at a central portion of ramp post 61, is penetrating screw portion 61a, as shown in FIG. 6A, and screw portions may be formed on its both end portions, respectively, in the same manner as above-described FPC post 32 (see, FIG. 3D), and they may not be disposed on the same axis center.

Further, in magnetic disk device 11 in the embodiment of the present invention, as shown in FIG. 6B, penetrating screw portion 4a, which is the same as screw portion 61a of ramp post 61, is disposed also at a central portion of turning shaft 4 of actuator 5, and upper side chassis 52 and lower side chassis 10 are fixed by screw 64 and screw 65 through through-holes disposed in the respective chassises, and thereby, it is possible to carry out positioning of actuator 5 at a predetermined position. There is not such a necessity that penetrating screw portion 4a, which is disposed at a central portion of turning shaft 4, is penetrated penetrating screw portion 4a, and screw portions may be formed on its both end portions, respectively, in the same manner as above-described FPC post 32 (see, FIG. 3D), and they may not be disposed on the same axis center.

As described above, in magnetic disk device 11 in the embodiment of the present invention, it is assumed that upper side chassis 52 and lower side chassis 10 are fixed by fastening portions, respectively in such a form that they sandwich FPC post 32, ramp post 61 and turning shaft 4, and they are also fixed at another portion, e.g., a portion in the vicinity of periphery of an outer circumference of upper side chassis 52 and lower side chassis 10, directly or indirectly.

As described previously, in magnetic disk device 11 in the embodiment of the present invention, by fixing FPC post 32 and ramp post 61 to upper side chassis 52 and lower side chassis 10, a positional relation of FPC substrate 21 of relay wiring body 7 to motor wiring body 1a which is disposed on spindle motor 1 attached to lower side chassis 10, as shown in FIG. 7, is determined, and a plurality of connecting portions 25, which are disposed at a front edge of relay wiring body 7, are pressed by biasing force of pressing elastic member 9 in a direction heading for a paper surface, and thereby, they are brought into contact with a plurality of electrically conductive portions 1b on motor wiring body 1a, respectively, and it is possible to carry out giving and receiving an electric signal between connecting portion 25 and electrically conductive portion 1b.

In addition, in magnetic disk device 11 in the embodiment of the present invention, as shown in FIG. 7, in the vicinity of such portions that a plurality of connecting portions 25 of FPC substrate 21, which is pressed by pressing elastic member 9 and configures relay wiring body 7, contact a plurality of electrically conductive portions 1b of motor wiring body 1a, respectively, width W₁ of connecting portion 25 of FPC substrate 21, which contacts electrically conductive portion 1b of motor wiring body 1a, is smaller than width W₂ of electrically conductive portion 1b of motor wiring body 1a. Further, it is desirable from the viewpoints of impact resistance and stability, to form it in such a manner that width W₁ of connecting portion 25 becomes larger than at least width W₃ of front edge portion 9b of pressing elastic member 9 which presses connecting portion 25 of FPC substrate 21. That is, by setting respective widths W₁, W₂ and W₃ so as to satisfy

W₂>W₁≧W₃,

even if a center of width W₁ of electrically conductive portion 21b at each connecting portion 25 of FPC substrate 21, a center of width W₂ of each electrically conductive portion 1b of motor wiring body 1a, and a center of width W₃ of front edge portion 9b of pressing elastic member 9 are slightly deviated one another, respective contacts of respective electrically conductive portions 1b of motor wiring body 1a and respective connecting portions 25 of FPC substrate 21 which correspond to them are ensured, and it is possible to lower such a possibility that respective slight mounting position displacements of FPC substrate 21 and pressing elastic member 9 to motor wiring body 1a bring about obstacles to giving and receiving an electric signal due to a contact of motor wiring body 1a and FPC substrate 21.

In addition, in such a portion that electrically conductive portion 1b of motor wiring body 1a of magnetic disk device 11 in the embodiment of the present invention contacts connecting portion 25 of FPC substrate 21, by applying gold plating to vicinity of at least such portions that electrically conductive portions 1b and connecting portions 25 contact, respectively, it is possible to make contact resistance nearly 0Ω. By this means, even if contact pressure of electrically conductive portion 1b and connecting portion 25 is changed by impact from an outside and vibration etc., it is possible to keep nearly 0Ω, as long as contact is maintained, without changing the contact resistance.

As described above, according to magnetic disk device 11 in the embodiment of the present invention, screw portion 32a, screw portion 61a and penetrating screw portion 4a, which are penetrated respectively, are disposed in FPC post 32, ramp post 61 and turning shaft 4 of actuator 5, so as to be able to be fixed to upper side chassis 52 and lower side chassis 10, respectively, and therefore, it is possible to attach relay wiring body 7, ramp block 6 and actuator 5 to respective predetermined positions on upper side chassis 52.

In addition, according to magnetic disk device 11 in the embodiment of the present invention, it is possible to bring each of electrically conductive portions 1b of motor wiring body 1a disposed on spindle motor 1 into contact with each of electrically conductive portions 21b of connecting portions 25 of FPC substrate 21 of relay wiring body 7 which correspond to them, by pressing due to pressing elastic member 9, and electrically connect them. On this account, even at the time of exchange of for example, spindle motor 1, magnetic recording medium 3 which is disposed on spindle motor 1, or another constituent element which is disposed on lower side chassis 10 due to failure, damage etc., if upper side chassis 52 portion and lower side chassis 10 are separated by carrying out processing of pulling out screw 55, screw 63 and screw 65 which are fixing FPC post 32, ramp post 61 and turning shaft 4, and lower side chassis 10, respectively, and of removing other fastening portion for fixing upper side chassis 52 and lower side chassis 10, in keeping such a situation that members such as relay wiring body 7, pressing elastic member 9, ramp block 6 and actuator 5 are mounted on upper side chassis 52, together with FPC post 32, ramp post 61 and turning shaft 4, it becomes possible to separate it from lower side chassis 10 on which spindle motor 1 and magnetic recording medium 3 disposed thereon etc. are mounted.

In addition, according to magnetic disk device 11 in the embodiment of the present invention, each of electrically conductive portions 1b of motor wiring body 1a is brought into contact with each of electrically conductive portions 21b of connecting portions 25 of FPC substrate 21 which correspond to them, by pressing due to pressing elastic member 9, so as to enable connecting them electrically, and therefore, a troublesome work such as removing soldering which was made to such a portion that the motor wiring body and the FPC substrate of the relay wiring body are electrically connected is not required, and it is possible to easily separate upper side chassis 52 and lower side chassis 10.

On the one hand, in magnetic disk device 11 in the embodiment of the present invention, at the time of repair or exchange of electric circuit component 22 having a circuit such as preamplifier circuit section 7a disposed on FPC substrate 21 of relay wiring body 7, a member which configures actuator 5, or air filter 58 attached to upper side chassis 52, if upper side chassis 52 and lower side chassis 10 are separated by carrying out processing of releasing screw engagements of screw 54, screw 62 and screw 64, which are fixing FPC post 32, ramp post 61 and turning shaft 4, and upper side chassis 52, respectively, and removing other means for fixing upper side chassis 52 and lower side chassis 10, it becomes possible to easily carry out repair or exchange of a failed member. In addition, also on the occasion of carrying out assembly after repair, each of electrically conductive portions 1b of motor wiring body 1a is brought into contact with each of electrically conductive portions 21b of connecting portions 25 of FPC substrate 21 which correspond to them, by pressing due to pressing elastic member 9, so as to enable connecting them electrically, and therefore, it is possible to easily assemble it, simply by attaching upper side chassis 52 to lower side, chassis 10, in the same manner as the above-described time of disassembly.

Next, as to an assembling method of magnetic disk device 11 in the embodiment of the present invention, its outline will be explained.

Firstly, as a first process, as shown in FIG. 8A, reinforcing plate 31 (not shown in FIG. 8A) is mounted on a surface opposite to a surface on which electrically conductive portion 21b of base material portion 21a is formed, and actuator wiring body 5a, which is formed integrally with FPC substrate 21 on which an electric circuit such as preamplifier circuit 7a is formed, is folded by nearly 90° at a broken line Y-Y line shown in FIG. 2 in a paper surface upper direction (valley folding direction), and folded by nearly 90° at a broken line Z-Z line in a paper surface upper direction (valley folding direction). Further, actuator wiring body 5a is folded by nearly 180° at a broken line V-V line in such a manner that its base material portions face each other (a mountain folding direction), and actuator wiring body 5a, which is folded by nearly 180° at the broken line V-V line, is sandwiched by cut and raised portions 5e of wiring attaching portion 5d of actuator 5, and signal wiring connecting portion 5c, which is folded by nearly 90° at the broken line Y-Y line, is mounted on wiring attaching portion 5d. In signal wiring connecting portion 5c of actuator wiring body 5a, signal wirings from a magnetic head (not shown in the figure) and voice coil 8 of actuator 5 are electrically connected by soldering etc.

Next, as shown in FIG. 8B, as a second process, FPC substrate 21, to which signal wiring of actuator 5 is electrically connected, is folded by nearly 180° at the broken line X-X line in FIG. 2, in such a manner that base material portion 21a in FPC substrate 21 faces to it, and pressing elastic member 9 is sandwiched by FPC substrate 21, through reinforcing plate 31 (not shown in FIG. 8B), and they are bonded by a method of a double-sided adhesive tape etc., to thereby realize such a situation that FPC substrate 21 is doubled.

As shown in FIG. 9A, as a third process, FPC post 32 is penetrated through FPC substrate 21 which became doubled by sandwiching pressing elastic member 9, and FPC substrate 21 and FPC post 32 is solder-fixed over an entire circumference of corner portion 32e of FPC post 32.

Further, as shown in FIG. 9B, as a fourth process, lower circular cylindrical portion 61b of ramp post 61 is penetrated through ramp post through-hole 9d of pressing elastic member 9 which is sandwiched by FPC substrate 21 through reinforcing plate 91 and mounted, and positioning hole 6b of ramp block 6 is fitted in upper circular cylindrical portion 61c of ramp post 61, and positioning protruding portion 6a of ramp block 6 is fitted in positioning hole 9e of pressing elastic member 9, and thereby, a position of ramp block 6 to pressing elastic member 9 is determined, and ramp block 6 is mounted on upper step surface 61e of flange portion 61d of ramp post 61.

Next, assembly jig 101 as shown in FIG. 10, in which a actuator positioning post 102 which is fitted in a screw hole of penetrating screw portion 4a for fixing turning shaft 4, around which actuator 5 turns, to lower side chassis 10, FPC positioning post 103 which is fitted in a screw hole of screw portion 32a of FPC post 32 for determining one position of relay wiring body 7, ramp positioning post 104 which is fitted in a screw hole of screw portion 61a of ramp post 61 for determining the other position of relay wiring body 7 and a position of ramp block 6, and concave portion 106 (which may be a through-hole) for avoiding contact of connector 23 and gasket 24 of relay wiring body 7, is prepared, and as a fifth process, as shown in FIG. 11A, actuator positioning post 102, FPC positioning post 103 and ramp positioning post 104 of assembly jig 101 are fitted and inserted in screw holes on the side of fixing to lower side chassis 10, of penetrating screw portion 4a of turning shaft 4 of actuator 5, screw portion 32a of FPC post 32 solder-fixed to relay wiring body 7, and screw portion 61a of ramp post 61 which is mounted on pressing elastic member 9 sandwiched by FPC substrate 21 configuring relay wiring body 7 through reinforcing plate 31 and on which ramp block 6 is mounted, respectively. Further, tab portion 5b, which is disposed on a front edge portion of actuator 5, is disposed on a flat surface which is a retracted position of ramp block 6.

As shown in FIG. 11A, a relative positional relation of FPC post 32 and ramp post 61 is determined by through-hole 9c and ramp post through-hole 9d in pressing elastic member 9 sandwiched by FPC substrate 21, and therefore, it is configured in such a manner that assembly workability on the occasion of assembling on assembly jig 101 is very excellent.

Further, as shown in FIG. 11B, as a sixth process, positioning protruding portion 51a and positioning protruding portion 51b, which are disposed on spacer 51 at two places, are fitted and inserted in positioning hole 21d and positioning hole 21e at two places (4 pieces in total) of relay wiring body 7, and spacer 51 is mounted on relay wiring body 7. By this means, it is possible to determine a position of spacer 51 to relay wiring body 7.

Next, as a seventh process, upper side chassis 52 is mounted on spacer 51 mounted on relay wiring body 7, FPC post 32 solder-fixed to relay wiring body 7, ramp block 6 mounted on upper step surface 61e of ramp post 61, and turning shaft 4 of actuator 5 mounted on actuator positioning post 102, and it is fixed with screw cramp by inserting screws in respective screw portions (61a, 32a) of turning shaft 4, ramp post 61 and EPC post 32, through respective hole portions disposed in upper side chassis 52, to form an upper side housing (first housing). For practical purposes, it may be configured in such a manner that a hole portion of upper side chassis 52, which corresponds to fastening of FPC post 32, is formed as a hole portion having an allowance to a screw external diameter such as a long hole, and at the time of assembly, turning shaft 4 and ramp post 61 are firstly fastened to upper side chassis 52, and then, EPC post 32 is fixed to upper side chassis 52.

Further, as an eighth process, the upper side housing, which is assembled in the above-described seventh process, is mounted on a lower side housing (second housing) in which spindle motor 1 is attached to a predetermined position of lower side chassis 10 and motor wiring body 1a is disposed at a predetermined position, and the lower side housing and the upper side housing are fastened, to finish a disk drive section.

Further, as a ninth process, electric circuit main substrate 53 is attached to the disk drive section, and thereby, it becomes possible to manufacture magnetic disk device 11. Here, such a situation that electric circuit main substrate 53 is incorporated in lower side chassis 10 together with spindle motor 1 and other constituent members may be set as the lower side housing, and at this time, it is possible to omit the ninth process.

As described above, in magnetic disk device 11 in the embodiment of the present invention, a process of disposing signal wiring connecting portion 5c which is disposed at an end portion of actuator wiring body 5a, at a predetermined position of actuator 5, and connecting respective signal wirings from a magnetic head and voice coil 8 which are disposed on actuator 5, to signal wiring connecting portion 5c is set as the first process, and thereby, a wiring from a magnetic head to a head amplifier becomes a closed circuit, and therefore, it is possible to prevent occurrence of such a trouble that a magnetic head is broken in consequence of static electricity etc.

In addition, in magnetic disk device 11 of the embodiment of the present invention, by assembling the above-described first housing and second housing, each of electrically conductive portions 21b in connecting portions 25 of EPC substrate 21 which configures relay wiring body 7 pressed by front edge portion 9b of pressing elastic member 9 is brought into contact with each of electrically conductive portions 1b in motor wiring body 1a disposed on lower side chassis 10, and each of electrically conductive portion 21b in connecting portions 25 of FPC substrate 21 is electrically connected to each of electrically conductive portion 1b in motor wiring body 1a.

In the above-described explanation of the assembling method of magnetic disk device 11, constituent members, which are necessary for the disk drive section such as an upper side yoke, a lower side yoke and a permanent magnet for configuring a voice coil motor, are incorporated in the upper side housing and the lower side housing. In addition, in reverse to assembly, at the time of disassembling magnetic disk device 11 which is assembled in this manner, motor wiring body 1a of spindle motor 1, which is attached to lower side chassis 10, is easily removed from connecting portion 25 of FPC substrate 21 of relay wiring body 7, by removing the lower side housing from the upper side housing, and it is possible to easily separate spindle motor 1 and actuator 5. By this means, even in case that there is need to exchange etc. for example, spindle motor 1 and magnetic recording medium 3, there is no need to remove actuator 5 from the housing, and it is possible to carry out a work without going to trouble at shorter times.

In magnetic disk device 11 in the embodiment of the present invention, it was described in such a manner that an elastic material having a spring characteristic is used as pressing elastic member 9 and front edge portions 9b, which presses connecting portions 25 of FPC substrate 21, are formed integrally with each other, but the present invention is not limited to this example. For example, as shown in FIG. 12, it is also possible to use such pressing elastic member 123 that elastic portions 122 having elasticity such as a rubber material and a cushion material are fixed to a plurality of bifurcation portions 121a disposed on base material portion 121 using a flat plate material such as SUS. It is desirable that, even when pressing elastic member 123 is formed in the suchlike shape, respective bifurcation portions 121a are formed in such a manner that a cross sectional area of a front edge portion becomes smaller than a cross sectional area of a root portion in the same manner as above-described front edge portion 9b. In addition, as bifurcation portion 121a, it is also possible to use a so-called plate spring member such as SUS, and it is possible to use an elastic member such as rubber.

In the embodiment of the present invention, the explanation was carried out by using magnetic disk device 11 as an example, but a disk device of the present invention is not limited to this at any rate, and for example, it may be applied to another non-contact type disk device such as a DVD device, a magnetic optical disk device and an optical disk device.

As described above, according to magnetic disk device 11 in the embodiment of the present invention, relay wiring body 7 is brought into contact with motor wiring body 1a of spindle motor 1 by pressing force of pressing elastic members 9, 123, and thereby, it is possible to give and receive an electric signal to and from electric circuit main substrate 53, and therefore, in a connecting portion of relay wiring body 7 and motor wiring body 1a, it is possible to easily realize the connection by combining upper side chassis 52 and lower side chassis 10, without requiring a complicated work such as soldering, and it is possible to shorten assembly time. In addition, when any trouble occurred in a member which configures the disk drive section in magnetic disk device 11, it is possible to separate upper side chassis 52 and lower side chassis 10, even at the time of repair and exchange of the damaged member, depending on a position where the member is disposed, over keeping such a situation that a part of a constituent member of magnetic disk device 11 is fixed to upper side chassis 52, and therefore, it is possible to easily carry out at least one of disassembly and assembly for repair and exchange. Therefore, a work for repairing and exchanging a damaged member becomes easy, and it is possible to shorten work time for repair and exchange.

Further, in magnetic disk device 11 in the embodiment of the present invention, it is possible to connect electric wirings for giving and receiving an electric signal from electric circuit main substrate 53 to the disk drive section of magnetic disk device 11 by one connector 23, and therefore, it is possible to reduce the number of components necessary for that connection, and it is possible to realize an inexpensive disk device.

Further, if an electronic equipment such as a portable telephone device, a portable audio player device, a disk reproducing device or a disk recording device is configured by incorporating the disk device of the present invention therein, it is possible to realize such a configuration that it is much easier to connect. FIG. 13 is a block diagram which shows a configuration of an electronic equipment in which the disk device in the embodiment of the present invention is incorporated.

As shown in FIG. 13, in electronic equipment 74 in the embodiment of the present invention, HDA (Head Disk Assembly or Hard Disk Assembly) section 71 excluding the control section from the configuration of above-described magnetic disk device 11 configures disk unit 72, and control section 73 for controlling HDA section 71 and electronic equipment circuit section 75 are disposed on electronic equipment 74. Disk unit 72 is attached to electronic equipment 74. In the suchlike configuration, HDA section 71 of disk unit 72 and control section 73 of electronic equipment 74 are connected by one terminal portion, and therefore, it is possible to easily carry out connection. Further, according to the disk device of the present invention, it is possible to dispose control section 73 of electronic equipment 74 and electronic equipment circuit section 75 on such a portion that a plurality of connectors are disposed in a conventional disk device (e.g., lower both side portions of magnetic recording medium 3 in FIG. 1), and it is possible to realize miniaturization of a configuration.

Further, in HDA section 71 in the embodiment of the present invention, each of a FPC post portion and a ramp post portion is fastened to an upper side chassis and a lower side chassis, and therefore, it is possible to provide electronic equipment 74 with high stiffness and excellent impact resistance. In an electronic equipment of the present invention, attaching directions of electronic equipment 74 and disk unit 72 are not limited, but by attaching a surface of the upper side chassis or the lower side chassis of disk unit 72 to electronic equipment 74, it is possible to realize a configuration with much higher stiffness.

As shown by a broken line of FIG. 13, it is also possible to configure in such a manner that disk unit 76 has HDA section and control section 73 and electronic equipment 77 has electronic equipment circuit section 75.

### INDUSTRIAL APPLICABILITY

As described above, according to the present invention, it is possible to perform such an advantage that it is possible to realize such a configuration that it is difficult to take a trouble at the time of disassembly and assembly, and therefore, it is useful as a disk device which is capable of easily carrying but at least any one of disassembly and assembly and an electronic equipment using it, etc.

1. A disk device comprising:
a recording medium;
a rotating portion which rotates the recording medium;
a head portion which carries out at least any one of reproducing and recording a signal from and on the recording medium;
an actuator portion which supports the head portion and can be turned around a shaft bearing portion as a turning center in a radius direction of the recording medium;
a ramp portion which holds a part of the actuator portion on the occasion of retracting the head portion of the actuator portion;
a circuit substrate portion which carries out at least any one of transmission and reception of a signal to and from at least the head portion and the actuator portion;
an upper side chassis; and
a lower side chassis,
wherein each of the shaft bearing portion of the actuator portion, the ramp portion and the circuit substrate portion has fastening portions on both sides thereof in a perpendicular direction to the recording medium, the actuator portion, the ramp portion and the circuit substrate portions being fixed to the upper side chassis and the lower side chassis.

2. The disk device of claim 1, wherein the ramp portion has a ramp block portion which holds a part of the actuator portion, and a ramp post portion which is disposed on the fastening portion.

3. The disk device of claim 2, wherein the ramp block portion and the ramp post portion are formed integrally.

4. The disk device of claim 1, wherein the circuit substrate portion has a FPC portion on which an electrically conductive pattern is formed, and a FPC post portion which passes through the FPC portion and
the fastening portion is disposed on the FPC post portion.

5. The disk device of claim 4, comprising a positioning member which determines a relative positional relation of the ramp post portion and the FPC post portion.

6. The disk device of claim 4, wherein the circuit substrate portion has an amplification circuit portion which amplifies an output from the head portion.

7. The disk device of claim. 2, wherein the ramp post portion is of a shape having at least two circular cylindrical portions with different radiuses each other and at least one step portion between the circular cylindrical portions, and when, among at least the two circular cylindrical portions, the ramp block portion is fitted in the circular cylindrical portion on the side of the upper side chassis against the step portion and the ramp post portion is fastened to the upper side chassis by use of the fastening portion, the ramp block portion is sandwiched by the upper side chassis and the step portion.

8. The disk device of claim 4, wherein the FPC post portion is of a shape having at least two circular cylindrical portions with different radiuses each other and at least one step portion between the circular cylindrical portions, and the step portion of the FPC post portion is fixed to the FPC portion.

9. The disk device of claim 8, wherein the FPC post portion is solder-fixed to a ground line formed on the FPC portion.

10. The disk device of claim 5, comprising a wiring body having an electrically conductive portion for carrying out at least any one of reception and transmission of an electric signal from and to a rotating portion, at an end portion,
wherein the FPC portion has an electrically conductive portion for carrying out at least any one of transmission and reception of an electric signal to and from the head portion and the actuator portion, and a connecting portion for contacting the electrically conductive portion of the wiring body, and
the positioning member has a front edge portion which is sandwiched by the FPC portion for pressing the connecting portion of the FPC portion in a direction of the electrically conductive portion of the wiring body, and
the connecting portion of the FPC portion is brought into contact with the electrically conductive portion of the wiring body by pressing force by the front edge portion of the positioning member, whereby, the connecting portion of the FPC portion and the electrically conductive portion of the wiring body are electrically connected.

11. The disk device of claim 10, wherein the actuator portion, the positioning member and the FPC portion are attached to the upper side chassis and
the rotating portion and the wiring body are attached to the lower side chassis and,
by assembling the upper side chassis and the lower side chassis, the connecting portion of the FPC portion and the electrically conductive portion of the wiring body are brought into contact with each other by pressing force of the front edge portion of the positioning member and thereby, connected electrically.

12. An electronic equipment comprising the disk device of claim 1.

13. The electronic equipment of claim 12, wherein a control section for controlling the disk device is disposed on the side of the electronic equipment.

14. The electronic equipment of claim 12, wherein a surface of the upper side chassis or the lower side chassis of the disk device is attached to the electronic equipment.
